(19) United States
(12) Patent Application Publication
(10) Pub. No.: US 2022/0229573 A1
(43) Pub. Date: Jul. 21, 2022

(54) MIGRATING APPLICATIONS ACROSS STORGE SYSTEMS

(71) Applicant: Hewlett Packard Enterprise Development LP, Houston, TX (US)

(72) Inventors: Sankar Ramasamy, Bangalore Karnataka (IN); Sijesh Thondapilly Balakrishnan, Bangalore Karnataka (IN); Aswin Jayaraman, Bangalore Karnataka (IN); Uday Bharadwaj, Bangalore Karnataka (IN); Alastair Slater, Chepstow (GB)

(21) Appl. No.: 17/304,332

(22) Filed: Jun. 18, 2021

(30) Foreign Application Priority Data
Jan. 20, 2021 (IN) 202141002817

(51) Int. Cl. G06F 3/06

(52) U.S. Cl. CPC G06F 3/0647; G06F 3/064; G06F 3/067; G06F 3/0604; G06F 3/0619

(57) ABSTRACT

Examples include migration of an application from a first storage system to a second storage system. Some examples identify a set of reference datablocks related to an application to be migrated, copy the set of reference datablocks and compute a snapshot delta value. When the snapshot delta value is less than the threshold value, the application is transitioned from the first storage system to the second storage system.

### BACKGROUND

A storage array network (SAN) is a dedicated network that provides access to consolidated data storage. A SAN enables a host client device to access storage volumes in a storage array for storing data related to applications hosted by the host client device. One or more applications may be migrated from one storage array to another. In order to migrate the application(s) from one storage array to another, data related to the applications is migrated from the storage array to the other storage array.

### BRIEF DESCRIPTION OF DRAWINGS

These and other features, aspects, and advantages of the present specification will become better understood when the following detailed description is read with reference to the accompanying drawings, wherein:

FIG. 1 is a block diagram of an example system for migrating an application from a first storage system to a second storage system prior to the migration;

FIG. 2 is a block diagram of the example system of FIG. 1 after the migration of the application;

FIG. 3 is a flow diagram of an example method for migrating an application from a first storage system to a second storage system;

FIG. 4 is a flow diagram of another example method for migrating an application from a first storage system to a second storage system; and

FIG. 5 is a block diagram of an example computing system including a processor and a machine-readable storage medium encoded with example instructions to migrate an application from a first storage system to a second storage system.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as coupled or associated, whether directly without any intervening elements or indirectly with at least one intervening element, unless otherwise indicated. Two elements can be connected mechanically, electrically, or communicatively linked through a communication channel, pathway, network, or system. The term “and/or” as used herein refers to and encompasses any and all possible combinations of the associated listed items. The term “based on” means based at least in part on. It will also be understood that, although the terms first, second, third, etc. may be used herein to describe various elements, these elements should not be limited by these terms, as these terms are only used to distinguish one element from another unless stated otherwise or the context indicates otherwise.

Data migration refers to transfer of data from a storage system, referred to herein as a source storage system to another storage system, referred to herein as a destination storage system. The source and destination storage systems may be computers or any devices capable of storing the data. Data migration may be needed, for example, when the source storage system is being replaced or upgrade, when some function of the source storage system is otherwise being moved to the destination storage system, or when the data needs to be temporarily stored elsewhere while an operation such as maintenance is performed on the source storage system. Data migration may also be used to consolidate data from multiple sources.

In this context, migration of an application allows any given source storage system on which the application is running to free up its resources by migrating the application to a destination storage system. To migrate an application from a source storage system to a destination storage system, data related to the application is transferred from the source storage system to the destination storage system, and then the application is transitioned from the source storage system to the destination storage system to be operated on the destination storage system. Transitioning the application means switching the functional use of storage from the first storage system to the second storage system for operating the application. During the migration process, there may be intervals during which the application is paused, causing a significant amount of downtime for migrating the application, which may adversely affect the overall performance. Furthermore, migration of a large amount of data, e.g., a database, may cause a significant amount of downtime for migrating some applications. Performing application migration with high efficiency and minimal downtime is challenging.

Examples described herein address these technological problems and provide reduced downtime for migrating applications and make the migration process faster and more efficient in block storage systems. The examples as described herein compute a snapshot delta value while copying a set of reference datablocks related to an application to be migrated from a first storage system to a second storage system and determine whether the snapshot delta value is less than a threshold value. Datablocks may be related to an application if they include data that support the operation of the application, user data associated with the application, or other data related to the application. The snapshot delta value indicates a set of differential datablocks, in an updated snapshot, that have been modified or created by the application after a reference snapshot including the set of reference datablocks was created. A reference snapshot is a snapshot, of one or more storage volumes, that includes reference datablocks and serves as a reference for determining an updated snapshot. An updated snapshot is a snapshot, of one or more storage volumes, including datablocks that have been modified or created with respect to that of the reference snapshot. When it is determined that the snapshot delta value is not less than the threshold value, the examples identify a next set of reference datablocks, copy the next set of reference datablocks and compute a next snapshot delta value which is checked against the threshold value. This process is iterated until the snapshot delta value is less than the threshold value. When it is determined that a snapshot delta value is less than the threshold value, the application is transitioned from the first storage system to the second storage system. The described examples, thus, provide techniques to perform the migration process of the application with little downtime when the transition occurs and with minimum interruption to the operation of the application as the datablocks being migrated are available for reading and writing at the first storage system.

As used herein, the term “datablock” may refer to a unit of space for storing data in a block storage system. On storing data, a quantity of datablocks in the storage system may be consumed by (or allocated to) the data. In other words, the data may occupy the datablocks in the storage system.

A snapshot refers to a point in time image of at least a portion of data stored in a storage system (e.g., a storage array). The snapshots can be used for various purposes, such as backup, creating a checkpoint for restoring the state of an application, a source for data mining. For instance, in case of a system crash or data getting corrupted, the snapshots can be used for restoring the data. Typically, a snapshot is created by copying the portion of data at a predetermined point in time to form an image of the portion of data in the storage system. The snapshot thus obtained is saved in a snapshot volume on the storage system. The point in time at which the snapshot is created may be predetermined and may be based on a variety of conditions such as, for example, a number of days and time elapsed since a last snapshot was created. Several snapshots may be maintained to record the changes over a period of time. Snapshots may be recorded periodically after a predetermined time interval or each time a transaction is performed on the portion of data. In an example, a snapshot may be created every time a transaction is performed i.e., when a portion of the data is created, modified or deleted.

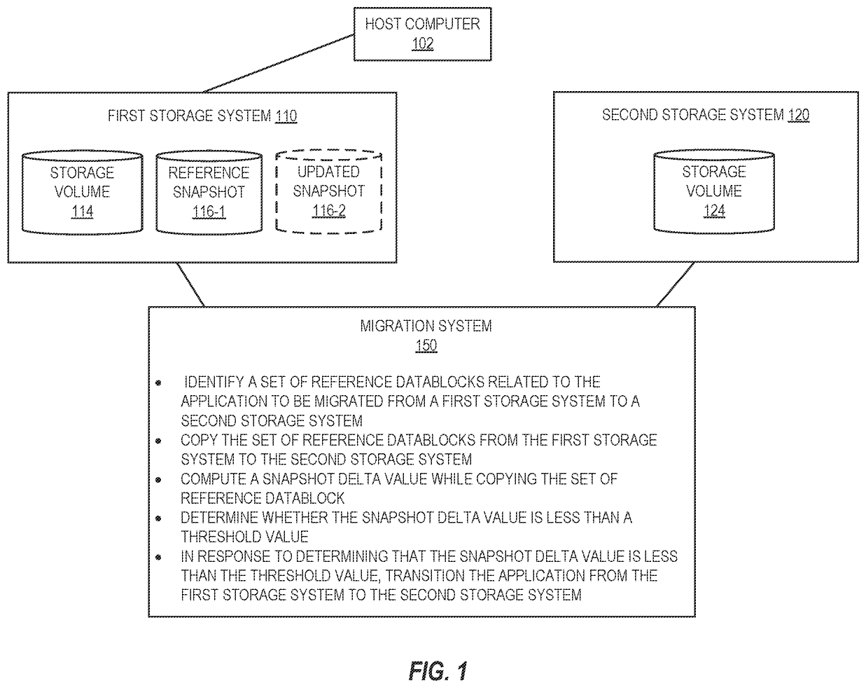

The above systems and methods are further described in conjunction with FIG. 1 to FIG. 5. It should be noted that the description and figures merely illustrate the principles of the present subject matter along with examples described herein and should not be construed as a limitation to the present subject matter. It will thus be appreciated that various arrangements that embody the principles of the present subject matter, although not explicitly described or shown herein, can be devised from the description and are included within its scope. Moreover, all statements herein reciting principles, aspects, and examples of the present subject matter, as well as specific examples thereof, are intended to encompass equivalents thereof.

FIG. 1 shows an example system 100 for performing a migration process to migrate an application from a first storage system 110 (i.e., a source storage system) to a second storage system 120 (i.e., a destination storage system). By the example, the system 100 includes a storage area network (SAN). The system 100 may include a host computer 102 coupled to the first storage system 110 and the second storage system 120 via the SAN. The system 100 includes a migration system 150 that performs migration of applications from the first storage system 110 to the second storage system 120. While only one host computer and two storage systems are illustrated for purposes of clarity and conciseness, the system 100 may have any number of storage systems and host computers coupled to one or more of the storage systems. Any functionality described herein as performed by a component (e.g., the host computer 102, the migration system 150, the first storage system 110 or the second storage system 120) of the system 100 may be performed by at least one processor (e.g., central processing unit (CPU), a semiconductor-based microprocessor, a graphics processing unit (GPU), an application-specific integrated circuit (ASIC), a field-programmable gate array (FPGA), etc.) of the component executing instructions stored on a machine-readable storage medium, such as random access memory (RAM), read-only memory (ROM), electrically erasable programmable read-only memory (EEPROM), flash memory, a hard disk drive, solid state disk, or the like to perform the functionalities described herein.

In particular, each of the first storage system 110 and the second storage system 120 may be a storage array, which may include storage volumes on one or more storage devices. For example, the first storage system 110 stores a storage volume 114 and the second storage system 120 stores a storage volume 124.

Further, each storage volume 114, 124 includes multiple datablocks to store data. While only one storage volume is illustrated in each of the first storage system 110 and the second storage system 120 for purposes of clarity and conciseness, the first storage system 110 and second storage system 120 may, individually, have any number of storage volumes. A storage volume is a logical unit of data storage that may be formatted to store data in the form of objects, directories, files, etc.

In examples described herein, storage devices may be a non-volatile storage device, such as a solid-state drive (SSD), a hard disk drive (HDD), a storage class memory (SCM) device, or the like. Storage devices of the first storage system 110 and the second storage system 120 may include SSD(s), HDD(s), SCM device(s), or the like, or any combination thereof. Examples of the first storage system 110 and the second storage system 120 include servers, personal computers, storage devices, or similar devices capable of storing data.

The host computer 102 may include, for example, a server computer, a mobile phone, laptop computer, desktop computer, or tablet computer, or the like. The host computer 102 may be hosting multiple applications. In particular, the host computer 102 may be a computing platform to execute the multiple applications.

In the examples described herein, the first storage system 110 provides storage to store data for one or more of the applications being hosted by the host computer 102 and data for one or more users of the host computer 102. One or more storage volumes may be occupied, at the first storage system 110, to store data for an application being hosted by the host computer 102. In certain examples, the first storage system 110 provides one storage volume for an application. For example, the storage volume 114 stores data for a given application being hosted by the host computer 102. In such examples, the host computer 102 is able to access the first storage system 110 and change at least a part of the data stored in the datablocks of the storage volume 114 upon occurrence of a transaction by the application. A transaction refers to a data modification operation (e.g., write operation) performed on datablocks of a storage system.

The first storage system 110 may include multiple snapshots of the storage volume 114 that may be periodically or occasionally created. The first storage system 110 may include a reference snapshot at a point in time. The reference snapshot (e.g., a reference snapshot 116-1) is a snapshot of the storage volume 114 that includes reference datablocks of the storage volume 114 at a point in time. At a later point in time, the first storage system 110 may include the reference snapshot (e.g., the reference snapshot 116-1) and an updated snapshot (e.g., an updated snapshot 116-2). An updated snapshot is a current snapshot that may be created when a transaction by an application occurs. In particular, an updated snapshot copies one or more datablocks that would be changed (i.e., modified or created) in a storage volume of the storage system due to a transaction after the reference snapshot was created. In some implementations, unchanged data in the storage volume is not copied to the updated snapshot, and only the changed datablocks are copied. In response to the transaction that changes the datablock(s) in the storage volume, the datablock(s) that would be changed in the storage volume are copied to the updated snapshot. The updated snapshot thus obtained includes changed datablock(s) that have been modified or created by the application after the reference snapshot was created. Thus, a reference snapshot is a previous snapshot that serves as a reference against which an updated snapshot is determined. The changed datablocks in the updated snapshot may be referred to as differential datablocks in the updated snapshot with respect to the reference snapshot. Yet, at a later point in time, the first storage system 110 may include a next updated snapshot which is determined against the previous updated snapshot that may serve as a reference snapshot for the next updated snapshot.

In the examples as illustrated in FIG.1, prior to performing the migration process, the second storage system 112 may or may not store any data for a host computer or users of the host computer. In an example, the datablocks of the storage volume 124 of the second storage system 120 may be partially or completely empty.

The migration system 150 may comprise a processor-based system, device or apparatus that may enable the functionalities of the migration system 150 as described herein. The migration system 150 may instead be a service or application executing on one or more processor-based systems. In an example, the migration system 150 may be implemented as a program of instructions that may be read by and executed on a processor.

The migration system 150 is to migrate an application from the first storage system 110 to another storage system (e.g., the second storage system 120) of the system 100. In the illustrated example, the migration system 150 is separate from the first storage system 110 and the second storage system 120. The migration system 150 may be included in a computing system such as a storage management system that can provide storage management for multiple storage systems. The migration system 150 may be in communication with, and otherwise manage multiple storage systems, which may or may not be at a common physical location, data center, region, etc. In some other examples, the migration system 150 may be implemented in the first storage system 110 or the second storage system 120.

In the examples described herein, migration of an application from the first storage system 110 to the second storage system 120 is described. Though the below description is about migrating one application, the migration system 150 can be used for migrating multiple applications simultaneously or sequentially to one or more other storage systems.

As described previously, the datablocks of the storage volume 114 may store data related to an application hosted by the host computer 102. In order to migrate that application, the migration system 150 first identifies all datablocks in the storage volume 114 to be migrated from the first storage system 110 to the second storage system 120. A snapshot created at this point in time, when the datablocks to be migrated are identified, is a reference snapshot at that point in time. This reference snapshot (e.g., the reference snapshot 116-1) includes the datablocks of the storage volume 114 being identified to be migrated, which may be referred to a set of reference datablocks. After the set of reference datablocks to be migrated is identified, the migration system 150 copies the reference datablocks from the storage volume 114 of the first storage system 110 to the storage volume 124 of the second storage system 120. In order to copy the reference datablocks, the migration system 150 may read the reference datablocks from the storage volume 114 and write the content of the reference datablocks in the datablocks of the storage volume 124.

While the set of reference datablocks is copied from the first storage system 110 to the second storage system 120, the application on the host computer 102 may send an input/output command to the first storage system 110 and a transaction may occur. Upon occurrence of the transaction, one or more datablocks of the storage volume 114 may be changed due to modification of the datablock(s) or one or more new datablocks may be created in the storage volume 114. The transaction may also include deleting data from datablock(s).

A snapshot (i.e., an updated snapshot) created at this point in time when the transaction by the application has been occurred may include the changed datablock(s), which may be referred to as differential datablock(s) (as described above). Accordingly, the updated snapshot includes a set of differential datablocks.

The updated snapshot is a snapshot including an image of the storage volume 114 including the set of differential datablocks that have been modified or created with respect to the reference snapshot. As described, the updated snapshot may be created after a transaction by the application occurred but while the set of reference datablocks is being copied to the second storage system 120. In this context, the reference snapshot may be defined as a previous snapshot including an image of the storage volume 114 in reference to which the set of differential datablocks, in the updated snapshot, is being determined. At that point in time, the first storage system 110 may include the reference snapshot (e.g., the reference snapshot 116-1) and an updated snapshot (e.g., the updated snapshot 116-2) as illustrated in FIG. 1, in an example.

The migration system 150 computes a snapshot delta value while copying the set of reference datablocks. The snapshot delta value indicates a set of differential datablocks, in the updated snapshot, that have been modified or created by the application after the reference snapshot was created. In order to compute the snapshot delta value, the migration system 150 may determine the differential datablocks in the updated snapshot with respect to the reference snapshot. In some examples, the migration system 150 may receive the updated snapshot from the first storage system 110 and determine a number of differential datablocks in the set of differential datablocks of the updated snapshot. For example, when the updated snapshot of the storage volume 114 includes 10 datablocks, the snapshot delta value is 10.

After computing the snapshot delta value, the migration system 150 determines whether the snapshot delta value is less than a threshold value. The threshold value is a predetermined snapshot delta value based on a predetermined downtime for the application while migrating the application. Downtime for an application may refer to a period of time during which the application is paused and cannot be operated. While migrating the application, the downtime for the application may include time taken in transitioning the application from the first storage system 110 to the second storage system 120. Transitioning the application may include making the first storage system 110 unavailable to the host computer 102 and making the second storage system 120 available to the host computer 102 to run the application. In other words, operation of the application is stopped on the first storage system 110 and then brought up and made operational on the second storage system 120. While transitioning the application, the set of differential datablocks (may also be referred to as a final set of differential datablocks to be migrated) indicated by the snapshot delta value and identified in the updated snapshot may be copied from the first storage system 110 to the second storage system 120. Copying the set of differential datablocks while transitioning the application may mean copying the differential datablock(s) of the final set of differential datablocks immediately before transitioning the application, in some examples. Accordingly, the downtime for transitioning the application includes time taken in copying the differential datablock(s) of the final set of differential datablocks and time taken in transitioning the application from the first storage system 110 to the second storage system 120. Thus, the downtime for transitioning the application depends on the time taken in copying the differential datablock(s) of the final set of differential datablocks indicated by the snapshot delta value.

A threshold value, as used herein, refers to a maximum number of datablocks that can be copied while transitioning an application from a first storage system to a second storage system in a predetermined downtime for the application. For example, when the predetermined downtime for transitioning an application allows for the time to copy 5 datablocks while transitioning the application, the threshold value may be set to 5. In some examples, a downtime for transitioning an application may be determined by estimating the time taken to copy a certain number of datablocks based on learnings from previously copied datablocks. In certain examples, the downtime may be estimated using machine learning.

In some examples, the migration system 150 determines that the snapshot delta value is less than the threshold value. In response to determining that the snapshot delta value is less than the threshold delta value, the migration system 150 proceeds to transition the application from the first storage system 110 to the second storage system 120. Before transitioning the application, the migration system 150 copies the differential datablock(s) of the final set of differential datablocks from the first storage system 110 to the second storage system 120. After copying the differential datablock(s), the migration system 150 transitions the application to the second storage system 120. In order to transition the application, the migration system 150 makes the first storage system 110 unavailable to the host computer 102 and makes the second storage system 120 available to the host computer 102 for performing any transaction related to the application.

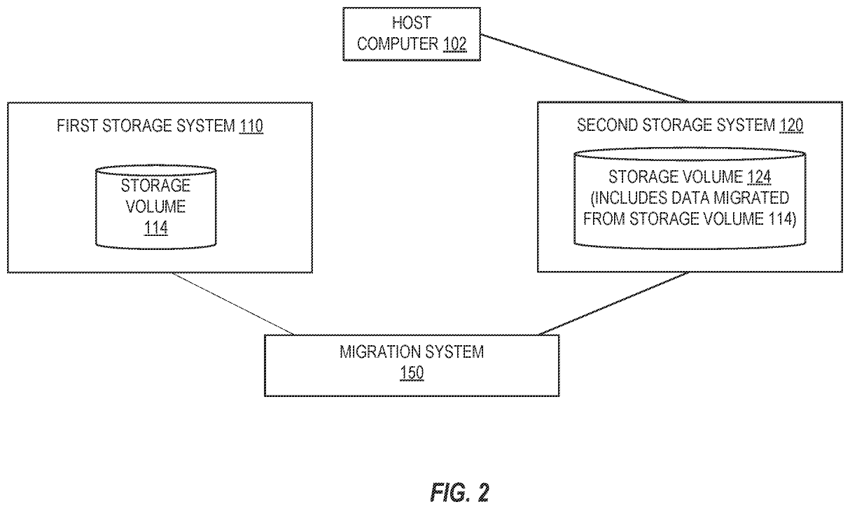

For example, FIG. 2 shows the system 100 of FIG. 1 after transitioning the application from the first storage system 110 to the second storage system 120. After transitioning the application, the host computer 102 is not able to access the first storage system 110. As illustrated, the host computer 102 can access the second storage system 120 and change at least a part of the data (migrated from the storage volume 114) stored in the datablocks of the storage volumes 124 upon occurrence of a transaction. In an example, the host computer 102 sends any input /output command with respect to the application to the second storage system 120.

In some examples, the migration system 150 determines that the snapshot delta value is not less than the threshold value. In response to determining that the snapshot delta value is not less than the threshold value, the migration system 150 performs a next iteration of identifying a set of reference datablocks, copying the identified set of reference datablocks, computing a snapshot delta value and determining whether the snapshot delta value is less than the threshold value. The next iteration of the identifying uses the previous set of differential datablocks as the set of reference datablocks (i.e., a next set of reference datablocks). In particular, the migration system 150 identifies the previous set of differential datablocks as a next set of reference datablocks, recomputes a snapshot delta value at a new point in time (i.e., to detect additional datablock changes made to the storage volume 114 at the first storage system 110 while copying the previous set of differential datablocks), and determines if the recomputed snapshot delta value meets the threshold value.

For example, consider that the previously discussed set of reference datablocks is a first set of reference datablocks and the set of differential datablocks is a first set of differential datablocks. Further, consider the reference snapshot to be a first reference snapshot, the updated snapshot is a first updated snapshot and the snapshot delta value is a first snapshot delta value.

Once it is determined that the first snapshot delta value is not less than the threshold value, the migration system 150 identifies a second set of reference datablocks, copies the second set of reference datablocks, computes a second snapshot delta value based on a second updated snapshot and determines whether the second snapshot delta value is less than the threshold value. In these examples, the second set of reference datablocks includes the previously determined first set of differential datablocks, which were associated with the first updated snapshot and the first snapshot delta value. Further, the first updated snapshot becomes a second reference snapshot that includes the second set of reference datablocks, in such examples.

While copying the second set of reference datablocks (that is, the first set of differential datablocks), the migration system 150 computes the second snapshot delta value in a similar fashion as discussed above with respect to computing the first snapshot delta value. To compute the second snapshot delta value, the migration system 150 retrieves the second updated snapshot from the first storage system 110 and determines a second set of differential datablocks from the second updated snapshot. The second updated snapshot includes the second set of differential datablocks that have been modified or created with respect to the second reference snapshot (i.e., the first updated snapshot) upon occurrence of another transaction. The migration system 150, then, determines whether the second snapshot delta value is less than the threshold value. In examples when the migration system 150 determines that the second snapshot delta value is less than the threshold value, the migration system 150 proceeds to transition the application from the first storage system 110 to the second storage system 120.

In examples when the migration system 150 determines that the second snapshot delta value is not less than the threshold value, the migration system 150 performs the identifying, copying, and computing steps again. In these examples, the migration system 150 identifies the second set of differential datablocks as a third set of reference datablocks, copies the third set of reference datablocks, computes a third snapshot delta value in a similar fashion as discussed above with respect to computing the second snapshot delta value, and determines whether the third snapshot delta value is less than the threshold value.

In some examples, the migration system 150 iteratively performs identifying, copying, and computing steps, as described above, until a snapshot delta value is less than the threshold value. In every next iteration, a set of differential datablocks in an updated snapshot of a previous iteration is identified as a set of reference datablocks (i.e., a next set of reference datablocks). Once the snapshot delta value less than the threshold value is achieved, the migration system 150 transitions the application from the first storage system 110 to the second storage system 120. This way, the described techniques can achieve a very short downtime when the transition of the application occurs.

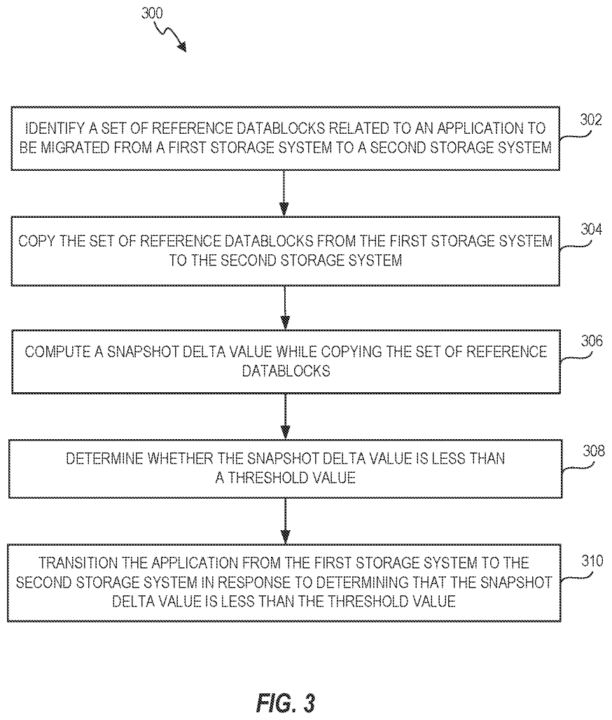

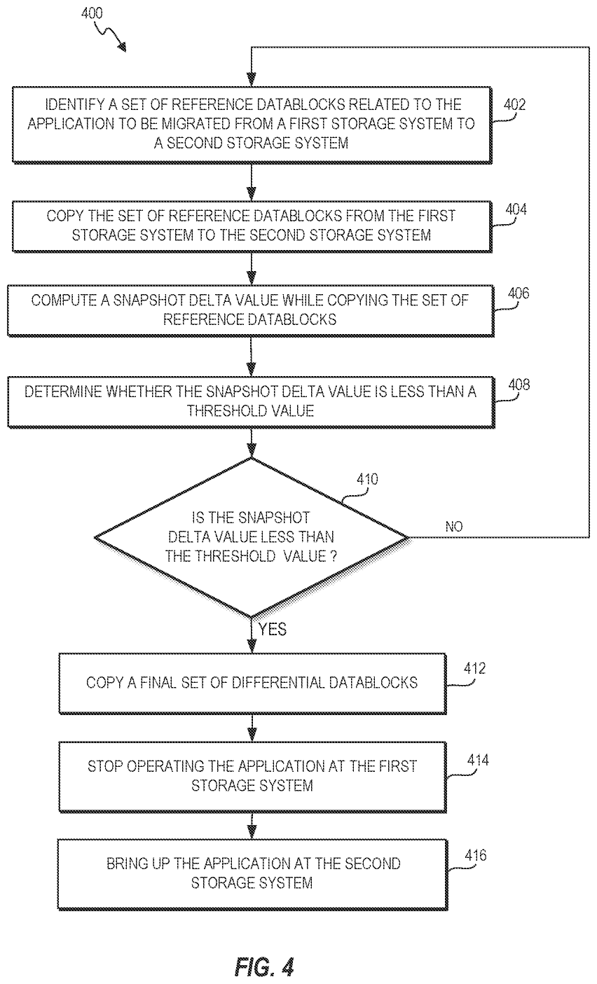

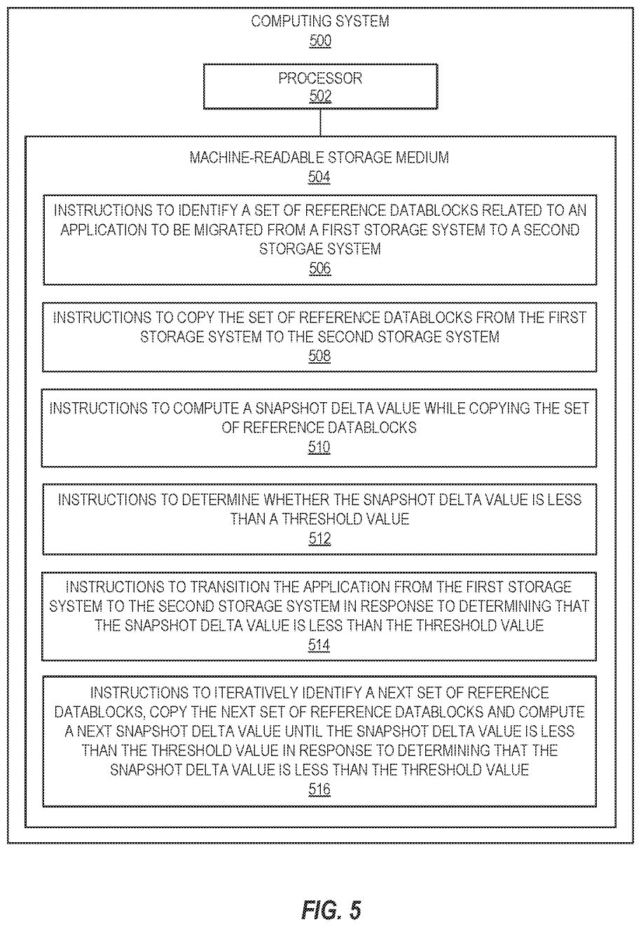

FIGS. 3 and 4 depict flowcharts of example methods 300 and 400 for migrating an application from a first storage system (e.g., the first storage system 110 of FIG. 1) to a second storage system (e.g., the second storage system 120). For illustration purposes, the execution of example methods 300 and 400 is described in conjunction with FIG. 1. Although the below description is described with reference to the migration system 150 of FIG. 1, other applications or devices suitable for the execution of methods 300 and 400 may be utilized. In some examples, the methods 300 and 400 may be executed by the computing system 500 (FIG. 5) via a processor 502 that executes the instructions 506-516 stored in the non-transitory machine-readable storage medium 504. Additionally, implementation of the methods 300 and 400 is not limited to such examples. Although the flowcharts of FIGS. 3 and 4, individually, show a specific order of performance of certain functionalities, methods 300 and 400 are not limited to such order. For example, the functionalities shown in succession in the flowcharts may be performed in a different order, may be executed concurrently or with partial concurrence, or a combination thereof.

Referring to FIG. 3, at block 302, a set of datablocks (i.e., reference datablocks) that relate to an application to be migrated from the first storage system 110 to the second storage system 120 is identified. In an example, the set of reference datablocks is identified from the storage volume 114 of the first storage system 110.

At block 304, the identified set of reference datablocks of the storage volume 114 is copied to the storage volume 124 of the second storage system 120. In an example, the reference datablocks from the storage volume 114 are read and then the content is written to the datablocks of the storage volume 124.

At block 306, a snapshot delta value is computed while copying the set of reference datablocks. The snapshot delta value indicates a set of differential datablocks, in an updated snapshot, that have been modified or created after a reference snapshot was created. The reference snapshot is a previous snapshot that includes the identified set of reference datablocks. In an example, the snapshot delta value is a number of differential datablocks in the set of differential datablocks of the updated snapshot. In some examples, the updated snapshot is retrieved from the first storage system 110 and a number of differential datablocks in the set of differential datablocks from the updated snapshot is determined to compute the snapshot delta value.

At block 308, it is determined whether the snapshot delta value is less than a threshold value (as described previously).

In response to determining that the snapshot delta value is less than the threshold value, at block 310, the application is transitioned from the first storage system 110 to the second storage system 120, as discussed above.

Referring to FIG. 4 now, the method 400 includes certain blocks that are similar to one or more blocks described in FIG. 3, details of which are not repeated herein for the sake of brevity. By way of example, the blocks 402, 404, 406 and 408 of FIG. 4 are similar to blocks 302, 304, 306 and 308, respectively, of FIG. 3.

At block 402, a set of reference datablocks that relate to the application to be migrated, is identified.

At block 404, the reference datablocks of the set of reference datablocks of the storage volume 114 are copied to the storage volume 124 of the second storage system 120. In an example, the reference datablocks are read from the storage volume 114 and then written to the datablocks of the storage volume 124.

At block 406, a snapshot delta value is computed while copying the set of reference datablocks.

At block 408, it is determined whether the snapshot delta value is less than the threshold value.

In some examples, the snapshot delta value is not less than the threshold value (‘NO’ at block 410). In these examples, the method 400 performs a next iteration of the identifying a set of reference datablocks, copying the identified set of reference datablocks and computing a snapshot delta value until a snapshot delta value less than the threshold value is achieved. The previously determined set of differential datablocks (i.e., from the immediately preceding iteration of block 406) is identified as a next set of reference datablocks (i.e., a set of reference datablocks for the current iteration). Upon identifying the next set of reference datablocks, the method 400 then proceeds to perform, at block 404, copying the identified next set of reference datablocks to the second storage system 120 and, at block 406, computing a next snapshot delta value based on a next updated snapshot while copying, as described above.

In some examples when it is determined that a snapshot delta value is less than the threshold value (‘YES’ at block 410), the application is transitioned from the first storage system 110 to the second storage system 120. The set of differential datablocks associated with the snapshot delta value that is less than the threshold value can be deemed a final set of differential datablocks, since no further iterations of blocks 402-410 will be performed. In order to transition the application, the method proceeds to block 412.

At block 412, the differential datablock(s) of the final set of differential datablocks are copied from the first storage system 110 to the second storage system 120.

At block 414, operation of the application on the first storage system 110 is stopped. In these examples, the first storage system 110 is made unavailable to operate the application, and no input/output commands are sent from the application to the first storage system 110.

At block 416, the application is brought up and started on the second storage system 120. In such examples, the second storage system 120 is made available to operate the application, and the application can send input/output commands to the second storage system 120.

FIG. 5 is a block diagram of a computing system 500 including a processor 502 and a machine-readable storage medium 504 encoded with example instructions 506, 508, 510, 512, 514 and 516 (506-516) to migrate an application from a first storage system (e.g., the first storage system 110 of FIG. 1) to a second storage system (e.g., the second storage system 120 of FIG. 1), in accordance with an example. The instructions 506-516 of FIG. 5, when executed by the processor 502, may implement some or all functions of a migration system (e.g., the migration system 150 of FIG. 1). In some examples, the computing system 500 may be included in (e.g., as part of) the migration system 150 of FIG. 1.

For ease of illustration, FIG. 5 is described with reference to FIG. 1. In certain examples, the instructions 506-516 may be executed for performing the functionalities of the migration system 150 or one or more methods, such as, the method 300 (FIG. 3) or 400 (FIG. 4). In certain examples, as an alternative or in addition to executing the instructions 506-516, the processor 502 may include at least one integrated circuit, other control logic, other electronic circuitry, or combinations thereof that include a number of electronic components for performing the functionalities described herein as being performed by the migration system 150.

Instructions 506, when executed by the processor 502, may identify a set of datablocks (i.e., reference datablocks) in the storage volume 114 of the first storage system 110 related to an application to be migrated.

Instructions 508, when executed by the processor 502, may copy the identified set of reference datablocks from the first storage system 110 to the second storage system 120. In an example, the instructions 508 include instructions, when executed by the processor 502, may read the reference datablocks from the storage volume 114 and write the content to the datablocks of the storage volume 124.

Instructions 510, when executed by the processor 502, may compute a snapshot delta value that indicates a set of differential datablocks in an updated snapshot while copying the set of reference datablocks. In an example, the snapshot delta value is a number of differential datablocks in the set of differential datablocks of the updated snapshot. In an example, instructions 510 may include instructions, when executed by the processor 502, may retrieve the updated snapshot from the first storage system 110 and determine a number of differential datablocks in the set of differential datablocks from the updated snapshot to compute the snapshot delta value.

Instructions 512, when executed by the processor 502, may determine whether the snapshot delta value is less than the threshold value.

In some examples, the snapshot delta value is less than the threshold value. In such instances, instructions 514, when executed by the processor 502, may transition the application from the first storage system 110 to the second storage system 120 as discussed above.

In some examples, the snapshot delta value is not less than the threshold value. In such instances, instructions 516, when executed by the processor 502, may repeat instructions 506-512 in an iterative manner. Instructions 506-512 may include instructions that, when executed by the processor 502, may identify a next set of reference datablocks. The next set of reference datablocks is the previously determined set of differential datablocks of the updated snapshot. Upon identifying the next set of reference datablocks, the instructions 506-512, when executed by the processor 502, may perform copying the next set of reference datablocks to the second storage system 120 and computing a next snapshot delta value based on a next updated snapshot. In some examples, the instructions 506-512 may include instructions that, when executed by the processor 502, may iteratively perform identifying a next set of reference datablocks, copying the next set of reference datablocks and computing a next snapshot delta value while copying the next set of reference datablocks until the snapshot delta value is less than the threshold value.

The instructions 506-516 may include various instructions to execute at least a part of the method 400 described in FIG. 4. Also, although not shown in FIG. 5, the machine-readable storage medium 504 may also include additional program instructions to perform various other method blocks described in FIG. 4.

As used herein, a “computing system” may be a server, storage device, storage array, desktop or laptop computer, switch, router, or any other processing device or equipment including a processor. In examples described herein, a processor may include, for example, one processor or multiple processors included in a single computing system or distributed across multiple computing systems. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. In examples described herein, a processor may fetch, decode, and execute instructions stored on a storage medium to perform the functionalities described in relation to the instructions stored on the storage medium. In other examples, the functionalities described in relation to any instructions described herein may be implemented in the form of electronic circuitry, in the form of executable instructions encoded on a machine-readable storage medium, or a combination thereof. The storage medium may be located either in the computing system executing the machine-readable instructions, or remote from but accessible to the computing system (e.g., via a computer network) for execution. In the examples illustrated in FIG. 1, the migration system 150 may be implemented by one machine-readable storage medium, or multiple machine-readable storage media.

As used herein, a “machine-readable storage medium” may be any electronic, magnetic, optical, or other physical storage apparatus to contain or store information such as executable instructions, data, and the like. For example, any machine-readable storage medium described herein may be any of RAM, EEPROM, volatile memory, non-volatile memory, flash memory, a storage drive (e.g., a hard disk drive (HDD), a solid-state drive (SSD)), any type of storage disc (e.g., a compact disc, a DVD, etc.), or the like, or a combination thereof. Further, any machine-readable storage medium described herein may be non-transitory machine-readable storage medium. In examples described herein, a machine-readable storage medium or media may be part of an article (or article of manufacture). All of the features disclosed in this specification (including any accompanying claims, abstract and drawings), and/or all of the elements of any method or process so disclosed, may be combined in any combination, except combinations where at least some of such features and/or elements are mutually exclusive.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

We/I claim:

1. A method for migrating an application, comprising:
identifying, by a processor-based migration system, a set of reference datablocks, related to the application, to be migrated from a first storage system to a second storage system;
copying, by the migration system, the set of reference datablocks from the first storage system to the second storage system;
computing, by the migration system, a snapshot delta value while copying the set of reference datablocks, wherein the snapshot delta value indicates a set of differential datablocks, in an updated snapshot, that have been modified or created by the application after a reference snapshot including the set of reference datablocks was created;
determining, by the migration system, whether the snapshot delta value is less than a threshold value; and
in response to determining that the snapshot delta value is less than the threshold value, transitioning, by the migration system, the application from the first storage system to the second storage system.

2. The method of claim 1, wherein:
in response to determining that the snapshot delta value is not less than the threshold value, performing a next iteration of the identifying, the copying, the computing and the determining,
wherein the next iteration of the identifying uses a set of differential datablocks in an updated snapshot of a previous iteration as the set of reference datablocks.

3. The method of claim 1, wherein the threshold value is defined based on a predetermined downtime for the application.

4. The method of claim 1, wherein the snapshot delta value is a number of differential datablocks in the set of differential datablocks of the updated snapshot.

5. The method of claim 1, wherein the computing the snapshot delta value comprises:
retrieving, by the migration system, the updated snapshot from the first storage system; and
determining, by the migration system, a number of differential datablocks in the set of differential datablocks from the updated snapshot.

6. The method of claim 1, further comprising copying, by the migration system, the set of differential datablocks from the first storage system to the second storage system immediately before or while transitioning the application.

7. A non-transitory machine-readable medium storing instructions that, when executed by a processor, cause the processor to:
identify a set of reference datablocks related to an application to be migrated from a first storage system to a second storage system;
copy the set of reference datablocks from the first storage system to the second storage system;
compute a snapshot delta value while copying the set of reference datablocks, wherein the snapshot delta value indicates a set of differential datablocks, in an updated snapshot, that have been modified or created by the application after a reference snapshot including the set of reference datablocks was created;
determine whether the snapshot delta value is less than a threshold value; and
in response to determining that the snapshot delta value is less than the threshold value, migrate the application from the first storage system to the second storage system.

8. The non-transitory machine-readable medium of claim 7, further storing instructions that, when executed by the processor, cause the processor to:
in response to determining that the snapshot delta value is not less than the threshold value, iteratively identify a next set of reference datablocks, copy the next set of reference datablocks and compute a next snapshot delta value until the snapshot delta value is less than the threshold value.

9. The non-transitory machine-readable medium of claim 7, wherein the threshold value is defined based on a predetermined downtime for migrating the application.

10. The non-transitory machine-readable medium of claim 7, wherein the instructions to compute the snapshot delta value comprise instructions that, when executed by the processor, cause the processor to:
retrieve the updated snapshot of the first storage system; and
determine a number of differential datablocks in the set of differential datablocks from the updated snapshot.

11. The non-transitory machine-readable medium of claim 7, further storing instructions that, when executed by the processor, cause the processor to:
copy the set of differential datablocks from the first storage system to the second storage system immediately before or while migrating the application.

12. A migration system comprising:
a processor; and
a machine-readable medium storing instructions that, when executed by the processor, cause the processor to:
identify a set of reference datablocks related to an application to be migrated from a first storage system to a second storage system;
copy the set of reference datablocks from the first storage system to the second storage system;
compute a snapshot delta value while copying the set of reference datablocks, wherein the snapshot delta value indicates a set of differential datablocks, in an updated snapshot, that have been modified or created by the application after a reference snapshot including the set of reference datablocks was created;
determine whether the snapshot delta value is less than a threshold value; and
in response to determining that the snapshot delta value is not less than the threshold value, iteratively identify a next set of reference datablocks, copy the next set of reference datablocks and compute a next snapshot delta value until the snapshot delta value is less than the threshold value.

13. The migration system of claim 12, wherein the migration system is included in a computing system that is separate from the first storage system and the second storage system.

14. The migration system of claim 12, wherein the snapshot delta value is a number of differential datablocks in the set of differential datablocks.

15. The migration system of claim 12, wherein the machine-readable medium stores further instructions that, when executed by the processor, cause the processor to:
in response to determining that the snapshot delta value is less than the threshold value, migrate the application from the first storage system to the second storage system.

16. The migration system of claim 15, wherein the machine-readable medium stores further instructions that, when executed by a processor, cause the processor to:
copy the set of differential datablocks from the first storage system to the second storage system immediately before or while migrating the application.

17. The migration system of claim 12, wherein the threshold value is defined based on a predetermined downtime for migrating the application.

18. The migration system of claim 12, wherein the instructions to compute the snapshot delta value comprise instructions that, when executed by a processor, cause the processor to:
retrieve the updated snapshot from the first storage system; and
determine a number of differential datablocks in the set of differential datablocks from the updated snapshot.
